(19) United States
(12) Patent Application Publication
(10) Pub. No.: US 2025/0336229 A1
(43) Pub. Date: Oct. 30, 2025

(54) Determination of Palm Position

(71) Applicant: Apple Inc., Cupertino, CA (US)

(72) Inventor: Alexander T. Wing, Fremont, CA (US)

(21) Appl. No.: 19/067,415

(22) Filed: Feb. 28, 2025

Related U.S. Application Data
(60) Provisional application No. 63/640,410, filed on Apr. 30, 2024.

(51) Int. Cl. G06V 40/10; G06F 3/01; G06T 7/70; G06V 40/18; G06V 40/20

(52) U.S. Cl. CPC G06V 40/11; G06F 3/013; G06F 3/017; G06T 7/70; G06V 40/18; G06V 40/28; G06T 2207/30196

(57) ABSTRACT

Input poses of a hand are determined to be in a palm-up position based on a pose of an arm using sensor data. The technique involves capturing sensor data of an arm in a first pose, where the arm includes a shoulder and a wrist. The technique further involves determining a spatial relationship between the wrist and the shoulder based on the sensor data, and classifying the first pose as an input pose if the spatial relationship satisfies a criterion. The criterion may be that an inside portion of the wrist faces the shoulder, which can be determined by using vector operations on the wrist location, the shoulder location, the elbow location, and the forearm direction.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties. In some embodiments, a user may use gestures to interact with the virtual content. For example, users may use gestures to select content, initiate activities, or the like. However, what is needed is an improved technique to improve the determination of hand pose.

### BRIEF DESCRIPTION OF THE DRAWINGS

FIGS. 1A-1B show example diagrams of a user using a hand pose as an input pose, in accordance with one or more embodiments.

FIG. 2 shows a flow diagram of a technique for determining whether a hand pose should be classified as an input pose, in accordance with some embodiments.

FIG. 3 shows a flowchart of a technique for determining whether the hand is in a palm-up input pose, in accordance with some embodiments.

FIGS. 4A-4B example diagrams for determining whether a hand is in a palm-up position, in accordance with some embodiments.

FIG. 5 shows a system diagram of an electronic device which can be used for gesture input, in accordance with one or more embodiments.

FIG. 6 shows an exemplary system for use in various extended reality technologies.

### DETAILED DESCRIPTION

This disclosure pertains to systems, methods, and computer readable media to enable gesture recognition and input. In some enhanced reality contexts, certain hand poses may be used as user input poses. For example, detection of a particular hand pose may trigger a particular user input action, or otherwise be used to allow a user to interact with an electronic device, or content produced by the electronic device. One classification of hand poses which may be used as user input poses may involve a hand being detected in a palm-up position.

According to one or more embodiments, determining whether a hand is in a palm-up input pose includes tracking not only the hand but additional joint location information for the arm, such as a shoulder position, wrist position, and/or elbow position. In some embodiments, the location information may be determined based on sensor data from sensors capturing the various joints. Additionally, or alternatively, location information for the various joints may be inferred or otherwise derived from sensor data capturing other portions of the user's body. In some embodiments, the shoulder position may be representative of a location of the shoulder, and may not be aligned with a real world location of the shoulder. For example, the shoulder position may be determined based on an offset distance from a head or headset position, or may use the head or headset position as the shoulder will be generally in the same vicinity as the head/headset with respect to the hand and wrist, in accordance with one or more embodiments. In some embodiments, a hand may be determined to be in a palm-up position if the inside portion of the user's wrist or forearm is facing the user's shoulder. To that end, a spatial relationship may be determined between the wrist and the shoulder based on the sensor data or otherwise based on the location information. If the wrist is determined to be facing a representative central portion of the user, such as the head or location of a head-worn device, shoulder, neck, upper torso, or the like, then the pose of the hand is classified as a palm-up input pose.

The determination as to whether the inside of the wrist is facing the shoulder may be made in a number of ways. In some embodiments, a first vector is determined from the wrist location and to the shoulder location. A second vector is determined from the elbow location and to the wrist location. A plane perpendicular to the second vector and intersecting the wrist location is determined. The first vector is projected onto the plane to obtain a third vector. A fourth vector is determined by the direction across the forearm from the Ulna (pinky) side to the Radius (thumb) side and is on the plane. A fifth vector is determined that originates at the wrist location and is perpendicular to the second and fourth vectors using the right-hand rule for the left arm and the left-hand rule for the right arm. That is, the fifth vector points in the palm direction rather than the back of hand direction. The third and fifth vectors are then compared. In particular, example, an angular difference between the third and fourth vectors may be determined on the plane. If the difference between the third and fifth vector satisfies a threshold, then the hand is considered to be in a palm-up position.

Other considerations may be used to determine whether a hand is in a palm-up position. For example, a determination may be made as to a current trajectory of the rotation of the forearm. As an example, a rotation in one direction may indicate that a pose should be classified as a palm-up position, whereas a rotation in an opposite direction may cause the pose to be ignored, or to be classified otherwise so that it is not used as user input. As another example, the device may be configured to perform eye tracking, and a gaze target may be used to determine intentionality of the pose. For example, if a user is looking in a direction that is not associated with any candidate input actions, then the pose may not be classified as an input pose. To that end, some embodiments described herein classify a hand pose based on an intentionality of the pose as a palm-up input pose.

Embodiments described herein provide an efficient manner for determining whether a user's hand is in a palm-up position using only standard joint positions and without requiring any additional specialized computer vision algorithms, thereby providing a less resource-intensive technique for determining an orientation of the palm. Further, embodiments described herein improve upon pose determination techniques by consideration of the position of the hand with respect to the body such that a hand can be determined to be in a palm-up position even if the user is not upright. Moreover, embodiments described herein provide improvements for measuring forearm supination.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

For purposes of this application, the term “input pose” refers to a body pose which, when recognized by a gesture-based input system, is used for user input.

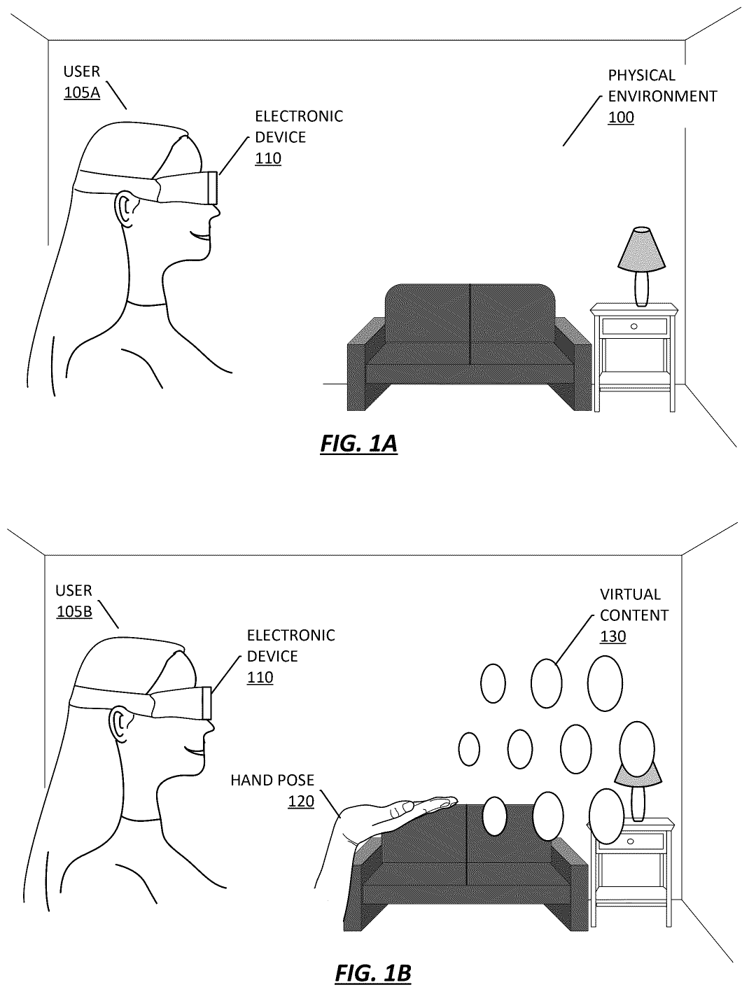

FIGS. 1A-1B show example diagrams of a user using a hand pose as an input pose, in accordance with one or more embodiments. In particular, FIG. 1A shows a user 105A using an electronic device 110 within a physical environment 100. According to some embodiments, electronic device 110 may include a pass through or see through display such that components of the physical environment 100 are visible. In some embodiments, electronic device 110 may include one or more sensors configured to track the user to determine whether a pose of the user should be processed as user input. For example, electronic device 110 may include outward-facing sensors such as cameras, depth sensors, and the like which may capture one or more portions of the user, such as hands, arms, shoulders, and the like. Further, in some embodiments, the electronic device 110 may include inward-facing sensors, such as eye tracking cameras, which may be used in conjunction with the outward-facing sensors to determine whether a user input gesture is performed.

Turning to FIG. 1B, a user 105B is shown performing an input gesture. In particular, user 105B now shows a hand in a hand pose 120 in which the palm is facing up. In some embodiments, some input gestures incorporate a palm-up position, such as the position presented with the hand of the user 105B held such that the palm and fingers are flat in a horizontal manner. In some embodiments, other input gestures may be detected with different hand poses that incorporate a palm-up position, such as an upward pinch or the like. As such, determination of the hand being in a palm-up position may be used, at least in part, to determine whether a user is performing a user input gesture. In this example, hand pose 120 causes virtual content 130 to be presented in a view of the physical environment 100. Accordingly, virtual content 130 may be visible on or through the electronic device 110, and is not physically present within the physical environment 100. For example, virtual content 130 may include graphical content, image data, or other content for presentation to a user. In this example, a graphical interface is presented with one or more icons for selection. To that end, the menu is presented in accordance with the determination that the hand pose 120 comprises a palm-up user input pose.

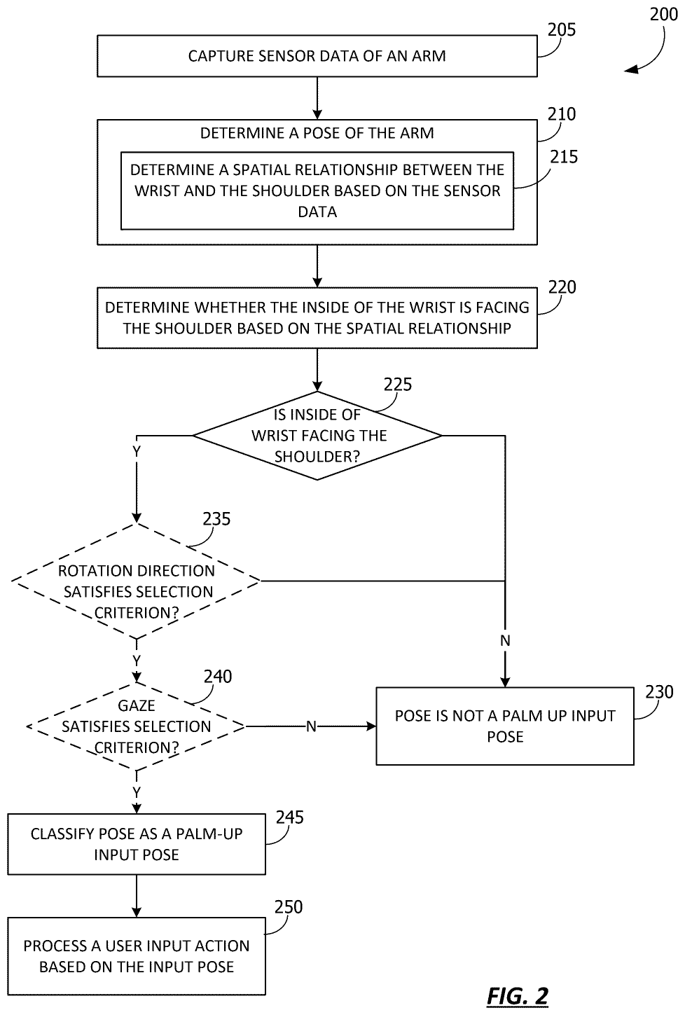

FIG. 2 shows a flow diagram of a technique for determining whether a hand pose should be classified as an input pose, in accordance with some embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 200 begins at block 205, where tracking data is obtained from sensors on an electronic device, such as cameras, depth sensors, or the like. The tracking data may include, for example, image data, depth data, and the like, from which pose, position, and/or motion can be estimated. In some embodiments, the tracking data may include or be based on additional sensor data, such as image data and/or depth data captured of a user's hand or hands. In some embodiments, the sensor data may be captured from sensors on an electronic device, such as outward-facing cameras on a head mounted device, or cameras otherwise configured in an electronic device to capture sensor data including a user's hands. In some embodiments, the sensor data may include position and/or orientation information for the electronic device from which location or motion information for the user can be determined.

The flowchart continues at block 210, and a pose of the arm is determined. The pose of the arm may be determined, for example, by the sensor data captured at block 205. In some embodiments, the pose of the arm may be determined by observing or determining joint locations in the arm, and determining a pose based on the joint locations. The pose may then be determined, for example, based on heuristics, machine learning models, inverse kinematics calculations, and the like. In some embodiments, as shown at block 215, the pose is determined based on a spatial relationship between the wrist and the shoulder, which may be determined based on the sensor data. For example, a representative location of the wrist, such as a location of a wrist joint, may be compared to a representative location of the shoulder, such as a location of a shoulder joint.

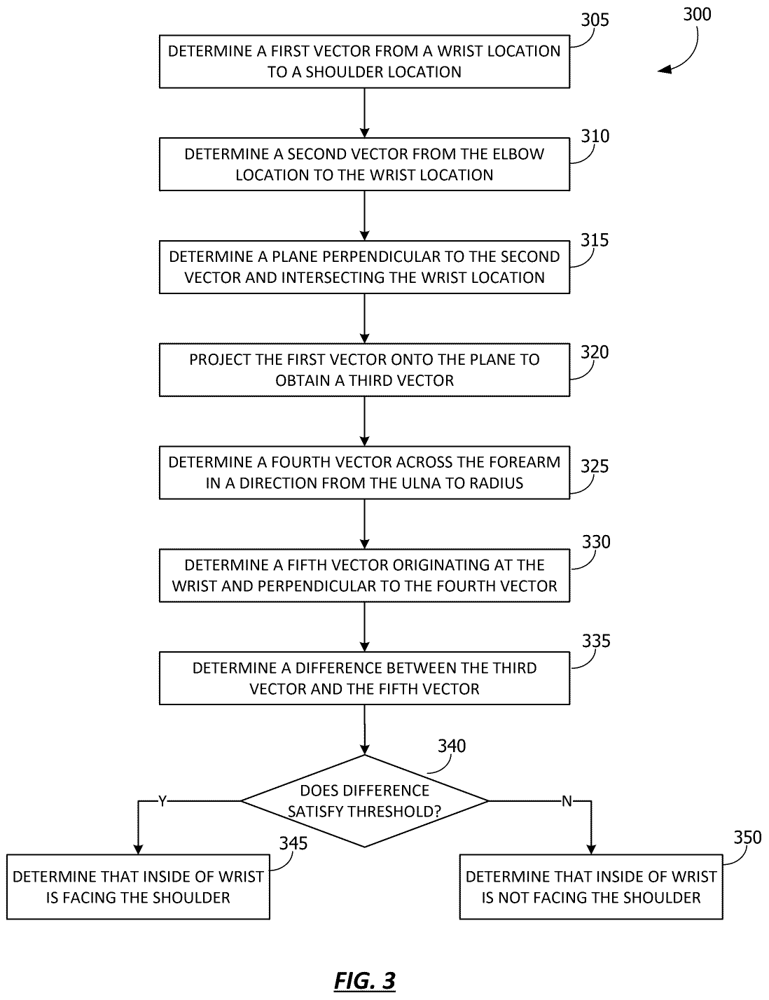

At block 220, a determination is made as to whether the inside of the wrist is facing the shoulder, based on the spatial relationship determined at block 215. For example, whether a hand is in a palm-up position may be alternatively determined based on whether a forearm or a wrist is facing the shoulder of the same arm. That is, and some embodiments, palm-up input poses maybe identified based on a palm-up position. However, a user may intend to be performing a palm-up position even if the palm is not facing an upward direction, such as a direction opposite of a gravitational vector. Accordingly, to better detect that a palm-up input pose is intended, a palm-up pose may be determined based on whether the inside of the wrist or forearm is facing the shoulder. The determination may be made based on joint locations, for example, of the elbow, wrist, and slash or shoulder. For example, the joint locations and other characteristics of the pose may be applied to a model or set of heuristics which indicate that the arm is in a palm-up position. Some embodiments for determining whether a hand is in a palm-up position will be described in greater detail below with respect to FIG. 3.

The flow chart continues to block 225, where a decision is made based on the determination as to whether the inside of the wrist is facing the shoulder. If the determination is made that the inside of the wrist is not facing the shoulder at block 220, then the flow chart concludes at block 230, and the pose is determined to not be a palm-up input pose. For example, the pose may be ignored with respect to the user interface, or may be classified as a non-palm-up pose, or the like.

Returning to block 225, if the determination is made that the inside of the wrist is facing the shoulder, then the flow chart optionally continues to block 235. At block 235, a determination is made as to whether a rotation direction satisfies the selection criterion. According to some embodiments, the determination of whether an arm is in a palm-up position may be determined based on a single frame of sensor data. Alternatively, as shown here at block 235, temporal data for motion of the user may be considered. For example, if a user is rotating into the pose from a rest position, then the pose will be determined to be a palm of input pose. Alternatively, if the arm is rotating into the pose from an over rotation of the arm, the pose may be determined not to be a palm-up input pose. Accordingly, the rotation direction may satisfy a selection criterion if the rotation direction is clockwise for a right arm or counterclockwise for a left arm. Thus, if the rotation direction does not satisfy a selection criterion, then the flow chart can conclude at block 230, where the pose is determined to not be in a palm-up input pose.

Returning to block 235, if a determination is made that the rotation direction does satisfy a selection criterion, or if optional block 235 is skipped, then the flow chart proceeds to optional block 240, where a determination is made as to whether gaze satisfies the selection criterion. According to some embodiments, gaze may be determined from sensor data captured by a same or different device as that capturing the sensor data of the arm at block 205. The sensor data used to detect gaze may include, for example, eye tracking cameras or other sensors on the device. For example, a head mounted device may include inward-facing sensors configured to capture sensor data of a user's eye or eyes, or regions of the face around the eyes which may be used to determine gaze. For example, a direction the user is looking may be determined in the form of a gaze vector. The gaze vector may be projected into a scene that includes physical and virtual content. According to some embodiments, whether gaze satisfies the selection criterion at block 240 may include a determination as to whether the gaze vector corresponds to a region of the environment for which an input action is available. For example, if a user performs a palm-up pose, but is not gazing at a portion of an environment at which input is allowed, then the gaze may be determined to not satisfy the selection criterion. Alternatively, if the user is gazing at or near (such as within a threshold distance) of a selectable virtual or physical component of the environment, the gaze may be considered to satisfy the selection criterion. In some embodiments, the gaze may be determined to satisfy the selection criterion based on whether a portion of the environment in which the user is gazing is available for display of virtual content which may be triggered by the palm-up input pose. For example, of virtual or physical constraints restrict virtual content from being presented at a portion of the environment corresponding to the gaze vector, then the gaze may be determined to not satisfy a selection criterion. If at blocked 240 a determination is made that the gaze does not satisfy the selection criterion, then the flow chart concludes at block 230, where the pose is determined to not be in a palm-up input pose.

If at block 240, a determination is made that the gaze does satisfy the selection criterion, or if block 240 is skipped and, at block 235, a determination is made that the rotation direction does satisfy a selection criterion, or if block 235 is additionally skipped, and at block 225 a determination is made that the inside of the wrist is facing the shoulder, then the flow chart proceeds to block 245. At block 245, the pose is classified as a palm-up input pose. The pose may be classified as a palm-up input pose indicating that the pose indicates that a user input action should be triggered, as shown at block 250. Alternatively, a determination that the pose is a palm-up input pose may be used as input to determine a particular type of input pose which should be processed, for example based on other characteristics of the pose such as finger position or the like.

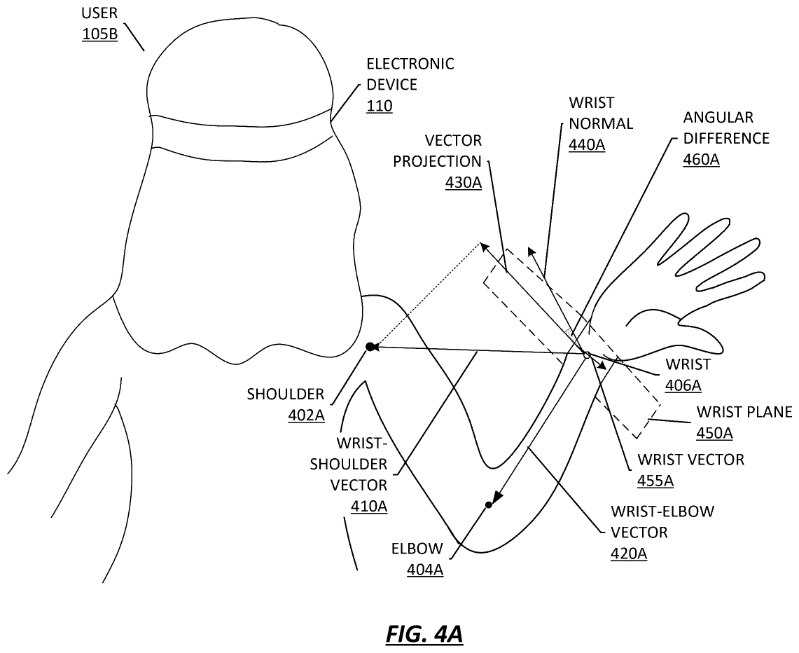

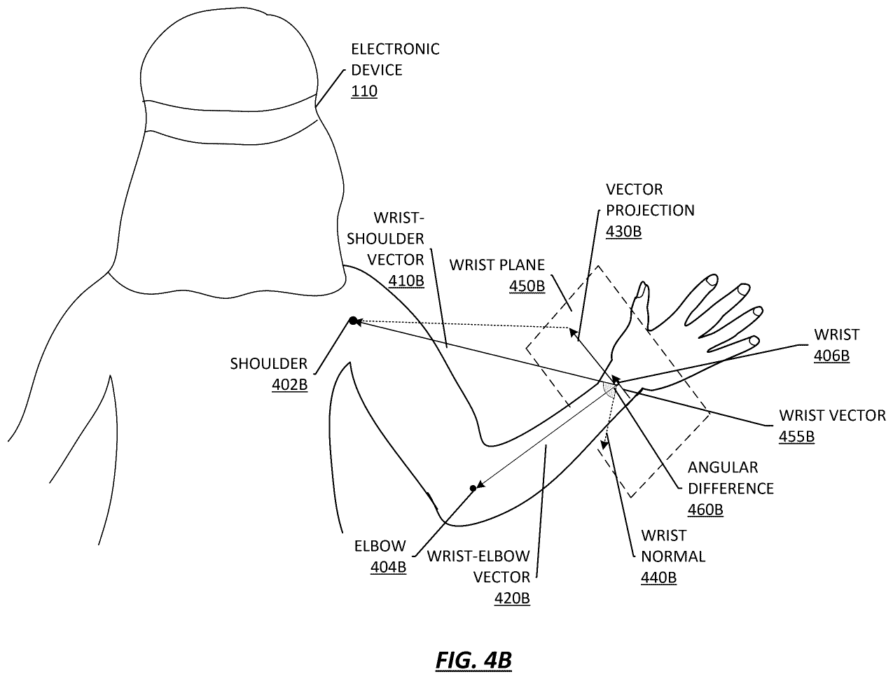

FIG. 3 shows a flowchart of a technique for determining whether the hand is in a palm-up input pose, in accordance with some embodiments. In particular, FIG. 3 shows a flowchart of a technique for determining characteristics of the pose from which a determination can be made as to whether a user intends a current pose to be a palm-up input pose, for example whether the inside of a wrist is facing a shoulder, as described above with respect to block 220 of FIG. 2. For purposes of explanation, the following steps will be described as being performed by particular components, and will be described in the context of FIGS. 4A-4B for clarity. However, it should be understood that the various actions may be performed by alternate components. The various actions may be performed in a different order. Further, some actions may be performed simultaneously, and some may not be required, or others may be added.

The flowchart 300 begins at block 305, where a first vector is determined based on a wrist location and a shoulder location. As described above with respect to FIG. 2, a wrist location and a shoulder location may be determined based on sensor data captured by one or more devices. The first vector may be a line in space which connects the wrist location and the shoulder location. For example, the first vector may be determined from the wrist location and to the shoulder location.

Turning to FIG. 4A, the shoulder location is shown at shoulder 402A, and the wrist location is shown as wrist 406A. Each of shoulder 402A and wrist 406A may correspond to points representative of a location of the shoulder or wrist. In some embodiments, the shoulder 402A may refer to a shoulder joint location, such as a location of a joint of a shoulder used in body tracking. In some embodiments, the shoulder location may be measured by downward-facing cameras or other sensors on the electronic device. Alternatively, a representative value may be used based on other position or orientation information captured by the electronic device 110. For example, an offset distance from the device may be used as an alternative determined location of shoulder 402B. Wrist 406A may correspond to a location of a wrist as provided by hand tracking functionality used to track a position and location of the hand or joints of the hand. Additionally, or alternatively, wrist 406A may refer to a representative of the location of the wrist based on body tracking techniques or other techniques used to track user motion, or may be based on an offset from a tracked location, such as one or more joints of the hand tracked by a hand tracking algorithm. The first vector is shown as wrist-shoulder vector 410A.

Returning to FIG. 3, the flowchart 300 proceeds to block 310, where a second vector is determined that includes the wrist location and an elbow location. For example, the vector may be determined from the elbow location and to the wrist location. The elbow location may be based on observed or determined location information for a point representative of the location of the elbow. For example, the elbow location may be measured by outward-facing cameras or other sensors on the electronic device. Alternatively, an elbow location may be derived based on observed data, such as a location of a shoulder and/or an arm or hand. The second vector may be a line in space which connects the wrist location and the elbow location. Turing again to FIG. 4A, the elbow location is shown at elbow 404A. The second vector is shown as the wrist-elbow vector 420A.

Returning to FIG. 3, at block 315, a plane is determined that is perpendicular to the second vector and which intersects the wrist location. In some embodiments, using the second vector ensures that the plane is perpendicular to the forearm. Turning to FIG. 4A, the plane is shown as wrist plane 450A, and is shown to be perpendicular to the wrist-elbow vector 420A. The wrist plane 450A intersects the wrist-elbow vector 420A at the wrist 406A.

The flowchart 300 of FIG. 3 proceeds to block 320, where the first vector from block 305 is projected onto the plane determined at block 320 to obtain a third vector. According to one or more embodiments, projecting the first vector onto the plane involves finding the component of the first vector that lies within the plane. This may be determined, for example, by the following calculation, where v is the first vector, and n is a normal vector to the plane, such as the second vector.

$${proj}_{plane} v = v - ( \frac{v \cdot n}{n \cdot n} ) n$$

Accordingly, the resulting projection will provide a third vector along the plane indicative of the component of the first vector that lies within the plane. Said another way, the third vector is the shadow of the first vector on the plane. Turning to FIG. 4A, the third vector is shown as vector projection 430A, which is shown as the shadow of the wrist-shoulder vector 410A onto the wrist plane 450A. Accordingly, the vector projection 430A is representative of the components of the wrist-shoulder vector 410A that lies on the wrist plane 450A.

Returning to FIG. 3, the flowchart 300 proceeds to block 325, where a fourth vector is determined across the forearm, in a direction from the ulna to radius. Thus, the fourth vector is on a same plane as the third vector. Turning to FIG. 4A, the fourth vector is shown as wrist vector 455A, which is shown as a vector across the forearm that lies on the wrist plane 450A.

At block 330, a fifth vector is determined originating at the wrist and which is perpendicular to the forearm. The fifth vector extends from the wrist in the direction corresponding to a direction the inside of the forearm is facing. In some embodiments, a forearm plane may be determined indicative of a plane lying across the inside of the forearm, from which the fifth vector is determined. In some embodiments, the fifth vector originates at the wrist location and is perpendicular to the second and fourth vectors using the right-hand rule for the left arm and the left-hand rule for the right arm. That is, the fifth vector points in the palm direction rather than the back of hand direction.

Turning to FIG. 4A, the fifth vector is shown as the wrist normal 440A, which extends from wrist 406A in a direction that is perpendicular to the forearm, such as a plane derived from the forearm, or a vector containing the ulna and radius. Accordingly, the forearm plane may include the wrist-elbow vector 420A and may extend in a direction based on a rotation of the forearm such that it aligns with a direction of the inside of the forearm. In some embodiments, the fifth vector originates at the wrist location and is perpendicular to the second and fourth vectors using the right-hand rule for the left arm and the left-hand rule for the right arm. That is, the fifth vector points in the palm direction rather than the back of hand direction.

The flowchart 300 proceeds to block 335, where a difference is determined between the third vector and the fifth vector. In some embodiments, the difference may be determined based on an angular distance between the third vector and the fifth vector. As shown in FIG. 4A, the angular difference 460A is shown as the difference between the vector projection 430A and the wrist normal 440A. A determination is made at block 340 as to whether the difference of block 335 satisfies a predefined threshold. If at block 340 a determination is made that the difference satisfies a predefined threshold, such as if the difference is less than a threshold difference value, then the flowchart concludes at block 345, and a determination is made that the inside of the wrist is facing the shoulder. As shown in FIG. 4A, it can be seen that the inside of the wrist 406A is facing the shoulder 402A. The determination can then be used to classify the pose as a palm-up pose and, in some embodiments, process a user input action based on the palm-up pose.

Returning to block 340, if a determination is made that the difference does not satisfy the predefined threshold, then the flowchart concludes at block 350, and a determination is made that the inside of the wrist is not facing the shoulder. Thus, the pose may be ignored for user input, or may be classified as not being a palm-up input pose.

Turning to FIG. 4B, an example diagram is shown of an arm that is not in a palm-up pose. In FIG. 4B, the shoulder location is shown at shoulder 402B, and the wrist location is shown as wrist 406B. Each of shoulder 402B and wrist 406B may correspond to points representative of a location of the shoulder or wrist, as described above. The first vector is shown as wrist-shoulder vector 410B, which corresponds to a line in space connecting the wrist 406B and the shoulder 402B. The elbow location is shown at elbow 404B. The second vector, comprising the wrist 406B and the elbow 404B, is shown as the wrist-elbow vector 420B.

A plane is determined that is perpendicular to the second vector and which intersects the wrist location. In some embodiments, using the second vector ensures that the plane is perpendicular to the forearm. In FIG. 4B, the plane is shown as wrist plane 450B, and is shown to be perpendicular to the wrist-elbow vector 420B. The wrist plane 450B intersects the wrist-elbow vector 420B at the wrist 406B. As described above, the first vector is projected onto the plane to obtain a third vector. According to one or more embodiments, projecting the first vector onto the plane involves finding the component of the first vector that lies within the plane. In FIG. 4B, the third vector is shown as vector projection 430B, which is shown as the shadow of the wrist-shoulder vector 410B onto the wrist plane 450B. Accordingly, the vector projection 430B is representative of the components of the wrist-shoulder vector 410B that lies on the wrist plane 450B.

As described above, a fifth vector is determined originating at the wrist and which is perpendicular to the forearm. The fifth vector extends from the wrist in the direction of the inside of the forearm, or the palm. In some embodiments, a forearm plane may be determined indicative of a plane lying across the inside of the forearm, from which the fifth vector is determined. Turning to FIG. 4B, the fifth vector is shown as the wrist normal 440B, which extends from wrist 406B in a direction that is perpendicular to the forearm, such as a plane derived from the forearm. Accordingly, the forearm plane may include the wrist-elbow vector 420B and may extend in a direction based on a rotation of the forearm such that it aligns with a direction of the inside of the forearm, such as wrist vector 455B. In some embodiments, the fifth vector originates at the wrist location and is perpendicular to the second and fourth vectors using the right-hand rule for the left arm and the left-hand rule for the right arm. That is, the fifth vector points in the palm direction rather than the back of hand direction

A difference is determined between the third vector (i.e., vector projection 430B) and the fifth vector (i.e., wrist normal 440B). In some embodiments, the difference may be determined based on an angular distance between the third vector and the fifth vector. As shown in FIG. 4B, the angular difference 460B is shown as the difference between the vector projection 430B and the wrist normal 440B. In comparison to the angular difference 460A of FIG. 4A, the angular difference 460B of FIG. 4B is much greater. As such, the angular difference 460B of FIG. 4B may be considered to not satisfy a difference threshold. Thus, the wrist may not be considered to face the shoulder, and the pose may be considered to not include a palm-up input pose. As shown in FIG. 4B, it can be seen that the inside of the wrist 406B is not facing the shoulder 402B. The determination can then be used to classify the pose as not a palm-up pose and/or can be used to disregard or ignore the pose as an input pose.

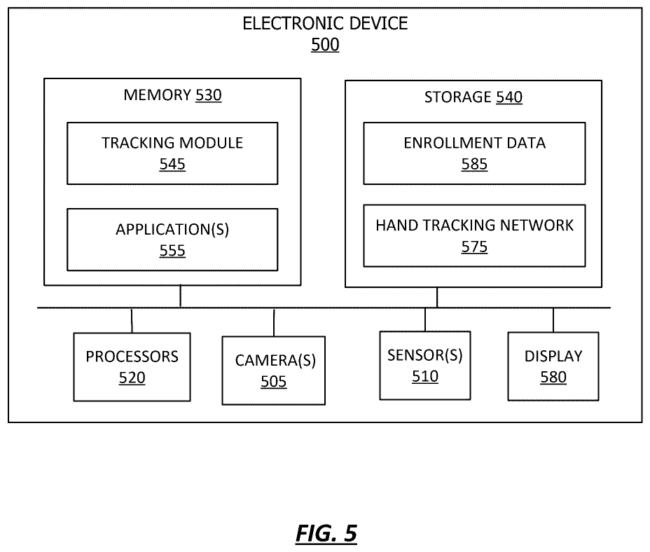

Referring to FIG. 5, a simplified block diagram of an electronic device 500 is depicted. Electronic device 500 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 500 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 500 is utilized to interact with a user interface of an application 555. According to one or more embodiments, application(s) 555 may include one or more editing applications, or applications otherwise providing editing functionality such as markup. It should be understood that the various components and functionality within electronic device 500 may be differently distributed across the modules or components, or even across additional devices.

Electronic Device 500 may include one or more processors 520, such as a central processing unit (CPU) or graphics processing unit (GPU). Electronic device 500 may also include a memory 530. Memory 530 may include one or more different types of memory, which may be used for performing device functions in conjunction with processor(s) 520. For example, memory 530 may include cache, ROM, RAM, or any kind of transitory or non-transitory computer-readable storage medium capable of storing computer-readable code. Memory 530 may store various programming modules for execution by processor(s) 520, including tracking module 545, and other various applications 555. Electronic device 500 may also include storage 540. Storage 540 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 540 may be utilized to store various data and structures which may be utilized for storing data related to hand tracking and UI preferences. Storage 540 may be configured to store hand tracking network 575, and other data used for determining hand motion, such as enrollment data 585, according to one or more embodiments. Electronic device 500 may additionally include a network interface from which the electronic device 500 can communicate across a network.

Electronic device 500 may also include one or more cameras 505 or other sensors 510, such as a depth sensor, from which depth of a scene may be determined. In one or more embodiments, each of the one or more cameras 505 may be a traditional RGB camera or a depth camera. Further, cameras 505 may include a stereo camera or other multicamera system. In addition, electronic device 500 may include other sensors which may collect sensor data for tracking user movements, such as a depth camera, infrared sensors, or orientation sensors, such as one or more gyroscopes, accelerometers, and the like.

According to one or more embodiments, memory 530 may include one or more modules that comprise computer-readable code executable by the processor(s) 520 to perform functions. Memory 530 may include, for example, tracking module 545, and one or more application(s) 555. Tracking module 545 may be used to track locations of hands, arms, joints, and other indicators of user pose and/or motion in a physical environment. Tracking module 545 may use sensor data, such as data from cameras 505 and/or sensors 510. In some embodiments, tracking module 545 may track user movements to determine whether to trigger user input from a detected input gesture. In some embodiments described herein, the tracking module 545 may be configured to determine whether a current pose of a user's arm satisfies criteria for a palm-up input pose. Electronic device 500 may optionally include a display 580 or other device by a user interface (UI) may be displayed or presented for interaction by a user. The UI may be associated with one or more of the application(s) 555, for example. Display 580 may be an opaque display, or may be semitransparent or transparent, such as a pass-through display or a see-through display. Display 580 may incorporate LEDs, OLEDs, a digital light projector, liquid crystal on silicon, or the like.

Although electronic device 500 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently, or may be differently directed based on the differently distributed functionality. Further, additional components may be used, some combination of the functionality of any of the components may be combined.

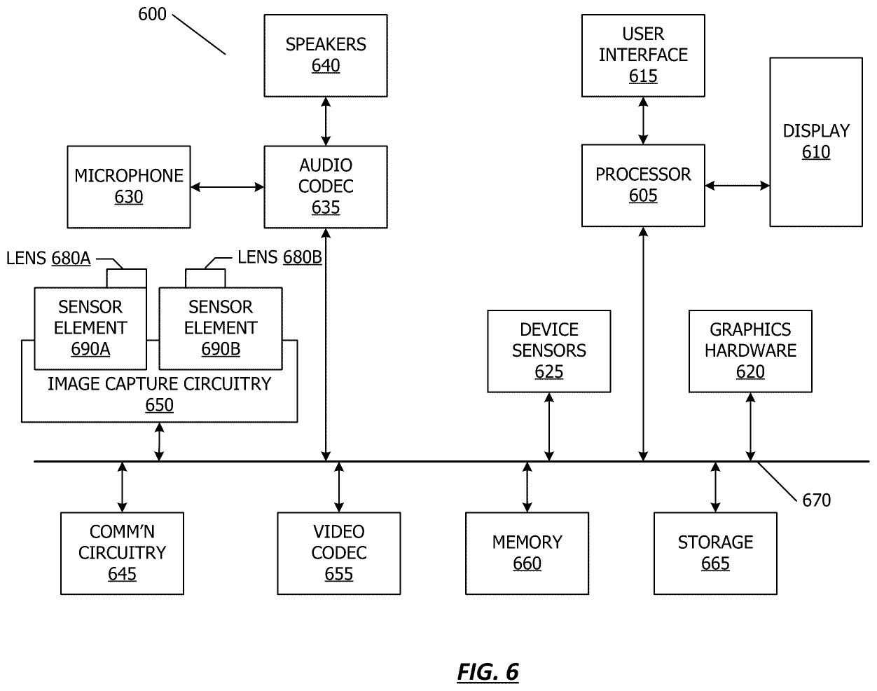

Referring now to FIG. 6, a simplified functional block diagram of illustrative multifunction electronic device 600 is shown according to one embodiment. Each of electronic devices may be a multifunctional electronic device or may have some or all of the described components of a multifunctional electronic device described herein. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system), video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, click wheel, keyboard, display screen, touch screen, gaze, and/or gestures. Processor 605 may also, for example, be a system-on-chip such as those found in mobile devices and include a dedicated GPU. Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed by video codec(s) 655 and/or processor 605 and/or graphics hardware 620, and/or a dedicated image processing unit or pipeline incorporated within circuitry 650. Images so captured may be stored in memory 660 and/or storage 665.

Sensor and camera circuitry 650 may capture still and video images that may be processed in accordance with this disclosure, at least in part, by video codec(s) 655 and/or processor 605 and/or graphics hardware 620, and/or a dedicated image processing unit incorporated within circuitry 650. Images captured may be stored in memory 660 and/or storage 665. Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 660 and storage 665 may be used to tangibly retain computer program instructions, or code organized into one or more modules and written in any desired computer programming language. When executed by, for example, processor 605 such computer program code may implement one or more of the methods described herein.

Various processes defined herein consider the option of obtaining and utilizing a user's identifying information. For example, such personal information may be utilized in order to track a user's pose and/or motion. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3-4 or the arrangement of elements shown in FIGS. 1-2, and 5-6 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium comprising computer readable code executable by one or more processors to:
capture sensor data of an arm comprising a shoulder and a wrist in a first pose;
determine a spatial relationship between the wrist and the shoulder based on the sensor data; and
in accordance with the spatial relationship satisfying a criterion, classify the first pose as an input pose.

2. The non-transitory computer readable medium of claim 1, wherein the computer readable code to determine the spatial relationship between the wrist and the shoulder comprises computer readable code to:
determine that an inside portion of the wrist faces the shoulder.

3. The non-transitory computer readable medium of claim 2, wherein the computer readable code to determine that the wrist faces the shoulder comprises computer readable code to:
determine a first vector comprising a wrist location and a shoulder location;
determine a plane perpendicular to a second vector comprising the wrist location and an elbow location, wherein the plane intersects the wrist location;
project the first vector onto the plane to obtain a third vector;
determine a fourth vector across a radius and ulna at the wrist;
determine a fifth vector originating at the wrist location and perpendicular to the fourth vector; and
compare the third vector and the fifth vector.

4. The non-transitory computer readable medium of claim 3, wherein the spatial relationship satisfies the criterion in accordance with the third vector and the fifth vector being within a threshold angle.

5. The non-transitory computer readable medium of claim 3, wherein the spatial relationship further satisfies the criterion in accordance with a determination that the arm moves into the first pose in a predefined direction.

6. The non-transitory computer readable medium of claim 5, wherein the predefined direction is clockwise for a right arm and counterclockwise for a left arm.

7. The non-transitory computer readable medium of claim 1, wherein the first pose is classified as an input pose further in accordance with a determination that a gaze target satisfies an input criterion.

8. A method comprising:
capturing sensor data of an arm comprising a shoulder and a wrist in a first pose;
determining a spatial relationship between the wrist and the shoulder based on the sensor data; and
in accordance with the spatial relationship satisfying a criterion, classifying the first pose as an input pose.

9. The method of claim 8, wherein determining the spatial relationship between the wrist and the shoulder comprises:
determining that an inside portion of the wrist faces the shoulder.

10. The method of claim 9, wherein determining that the wrist faces the shoulder comprises:
determining a first vector comprising a wrist location and a shoulder location;
determining a plane perpendicular to a second vector comprising the wrist location and an elbow location, wherein the plane intersects the wrist location;
projecting the first vector onto the plane to obtain a third vector;
determining a fourth vector across a radius and ulna at the wrist;
determining a fifth vector originating at the wrist location and perpendicular to the fourth vector; and
comparing the third vector and the fifth vector.

11. The method of claim 10, wherein the spatial relationship satisfies the criterion in accordance with the third vector and the fifth vector being within a threshold angle.

12. The method of claim 8, wherein the first pose is classified as an input pose further in accordance with a determination that a gaze target satisfies an input criterion.

13. The method of claim 8, further comprising:
processing the first pose as a user input action in accordance with the classification of the first pose as the input pose.

14. The method of claim 13, wherein processing the first pose as a user input pose further comprises triggering an action corresponding to the user input action in accordance with an additional input signal satisfying an action criterion.

15. The method of claim 14, wherein the sensor data further comprises eye tracking data, and wherein the action corresponding to the user input action is determined based on a gaze target.

16. A system comprising:
one or more processors; and
one or more computer readable media comprising computer readable code executable by one or more processors to:
capture sensor data of an arm comprising a shoulder and a wrist in a first pose;
determine a spatial relationship between the wrist and the shoulder based on the sensor data; and
in accordance with the spatial relationship satisfying a criterion, classify the first pose as an input pose.

17. The system of claim 16, wherein the computer readable code to determine the spatial relationship between the wrist and the shoulder comprises computer readable code to:
determine that an inside portion of the wrist faces the shoulder.

18. The system of claim 17, wherein the computer readable code to determine that the wrist faces the shoulder comprises computer readable code to:
determine a first vector comprising a wrist location and a shoulder location;
determine a plane perpendicular to a second vector comprising the wrist location and an elbow location, wherein the plane intersects the wrist location;
project the first vector onto the plane to obtain a third vector;
determine a fourth vector across a radius and ulna at the wrist;
determine a fifth vector originating at the wrist location and perpendicular to the fourth vector; and
compare the third vector and the fifth vector.

19. The system of claim 16, wherein the computer readable code to determine the spatial relationship between the wrist and the shoulder comprises computer readable code to:
determine that an inside portion of the wrist faces the shoulder.

20. The system of claim 16, wherein the first pose is classified as an input pose further in accordance with a determination that a gaze target satisfies an input criterion.
